(19) United States
(12) Patent Application Publication
(10) Pub. No.: US 2014/0293736 A1
(43) Pub. Date: Oct. 2, 2014

(54) LOW COMPLEXITY MOTION COMPENSATING BEAMFORMING SYSTEM AND METHOD THEREOF

(71) Applicant: NATIONAL TAIWAN UNIVERSITY, Taipei City (TW)

(72) Inventors: Kuan Yu HO, Taipei City (TW); An Yeu WU, Taipei City (TW); Pai Chi LI, Taipei City (TW); Cheng Zhou ZHAN, Taipei City (TW); Yu Hao CHEN, Taipei City (TW)

(73) Assignee: NATIONAL TAIWAN UNIVERSITY, Taipei City (TW)

(21) Appl. No.: 13/854,098

(22) Filed: Mar. 31, 2013

(51) Int. Cl. G01S 7/02; G01S 15/02

(52) U.S. Cl. CPC G01S 7/02; G01S 15/02
USPC 367/7

(57) ABSTRACT

A low complexity motion compensating beamforming system utilizes a probe array to fire for beamforming by synthetic apertures. The beamforming range of each firing is a region of interest (ROI), and the common area of adjacent ROI's forms the common ROI. The central image beam of the common ROI is used to generate image beam vectors, in order to analyze the cross-correlation for the corresponding low resolution images (LRI's). The analysis result is used to compute an offset for sequentially compensating and combining the LRI's to form a high resolution image (HRI). The mechanism helps improve the quality of ultrasonic beamforming and the frame rate.

### BACKGROUND OF RELATED ART

1. Technical Field

The invention relates to a beamforming system with motion compensation and the method thereof. In particular, the invention relates to a low complexity motion compensation beam forming system that generates low resolution images (LRI's) by synthetic apertures and performs motion compensation at the same time.

2. Related Art

Ultrasonic imaging systems can provide clinic information of physiological tissues, blood flows, and so on. In comparison with other medical imaging systems, such as: X-ray, computer tomography and magnetic resonance imaging, ultrasonic imaging systems have the features of non-invasion, non-radioactivity, lower costs, high imaging rates and portability. The most important module in the ultrasonic imaging system is beamforming. It is one of the most urgent tasks for vendors and experts to quickly produce high-quality images.

In general, beamforming involves real apertures and synthetic apertures. The synthetic aperture has lower complexity and cost, and is suitable for portable high-speed ultrasonic imaging systems, thus attracting most attention. However, the images output by the synthetic aperture is formed by superpositioning multiple probe firings. If a target object has a displacement during beamforming process, inhomogeneous phenomena will happen in the image data. This greatly affects the imaging quality of the ultrasonic imaging system.

In view of this, a displacement compensation method has been proposed. Specific probes (probes in the middle) are fired many times to determine the displacement for estimation and compensation. Although the above-mentioned can be used for the displacement compensation, the computation complexity is high because data of all channels are required. Moreover, the method needs to have more firings of the probes to determine the displacement. The frame refresh rate thus reduces. Therefore, the above-mentioned method cannot effectively solve the problem that the ultrasonic imaging quality is affected by a moving target object, which in turn results in poor image quality.

In summary, the ultrasonic imaging quality in the prior art has long been affected by the motion of a moving target object, and thus has poor image quality. It is necessary to provide an improved technical means to solve this problem.

### SUMMARY

The invention discloses a low complexity motion compensating beamforming system and the method thereof.

The disclosed system includes: a probe array, an image forming module, a vector module, a compensating module, and a generating module. The probe array includes I probes and, at the same time, J of the probes fire to beamform images, where I and J are positive integers and J < I. The probe array continuously uses different J probes to fire and beamform images. The beamforming range of each firing is a region of interest (ROI). Different ROI's are used in sequence to generate first to K-th LRI's, where K is a positive integer. The overlapped region of adjacent two ROI's forms the common ROI. The central image beam of the common ROI is used to generate image beam vectors. A cross-correlation function is used to perform a correlation analysis for the corresponding LRI's. The analysis result is used to compute an offset for sequentially compensating and combining the second to the K-th LRI's to form first to (K−1)-th low resolution compensating images. The first LRI and the sequentially generated first to (K−1)-th low resolution compensating images are combined to generate a high resolution image (HRI).

The disclosed method includes the steps of: providing in advance a probe array having I probes and using J of the probes at the same time to fire to beam form images, where I and J are positive integer with J<I; using the probe array to continuously use different J of the probes to fire to beamform images, the beamforming range of each firing is an ROI and different ROI's are used in sequence to generate first to K-th LRI's, where K is a positive integer; defining overlapped region of each two adjacent ROI's as an common ROI, and using the central image beam of the common ROI to generate image beam vectors; using a cross-correlation function to analyze the correlation of the LRI's corresponding to the beam vectors, and using the analysis result to compute an offset for sequentially compensating and combining the second to the K-th LRI's to form first to (K−1)-th low resolution compensating images; and combining the first LRI and the sequentially generated first to (K−1)-th low resolution compensating images to generate an HRI.

The disclosed system and method differ from the prior art in that the invention uses the probe array to fire for beamforming by synthetic apertures. The beamforming range of each firing is the ROI. The overlapped region of adjacent ROI's is used as the common ROI. The central image beam of the common ROI is used to generate image beam vectors, in order to perform a cross-correlation analysis for the corresponding LRI's. The analysis result is used to compute the offset to compensate the images and to generate an HRI.

The above-mentioned technique can improve the ultrasonic imaging quality and frame refresh rate.

### BRIEF DESCRIPTION OF THE DRAWINGS

The invention will become more fully understood from the detailed description given herein below illustration only, and thus is not limitative of the present invention, and wherein:

FIG. 1 is a system block diagram of the disclosed low complexity motion compensation beamforming system;

FIG. 2 is a flowchart of the disclosed low complexity motion compensation beamforming method;

FIG. 3 is a schematic view of the disclosed probe array firing beamforming;

FIG. 4 is a schematic view of the forward beam vectors and backward beam vectors; and

FIG. 5 is a schematic view of using the invention to generate a high resolution image.

### DETAILED DESCRIPTION

The present invention will be apparent from the following detailed description, which proceeds with reference to the accompanying drawings, wherein the same references relate to the same elements.

Before explaining the disclosed system and method, we first explain the environment used by the invention. The invention is used in an ultrasonic image system and, in particular in a motion estimation module, to enhance the ultrasonic image quality. The following defines the terms used in the specification. The region of interest (ROI) refers to the beamforming range of each firing of a probe. The common region of interest (common ROI) refers to the overlapped region of the beamforming range of adjacent two firings. The image beam vector is established according to the central or part of the beams in the overlapping ROI. The image beam vectors of the part overlapping with the previous image are called backward beam vectors. The image beam vectors of the part overlapping with the next image are called forward beam vectors. The forward and backward beam vectors will be described in detail with reference to accompanying figures later.

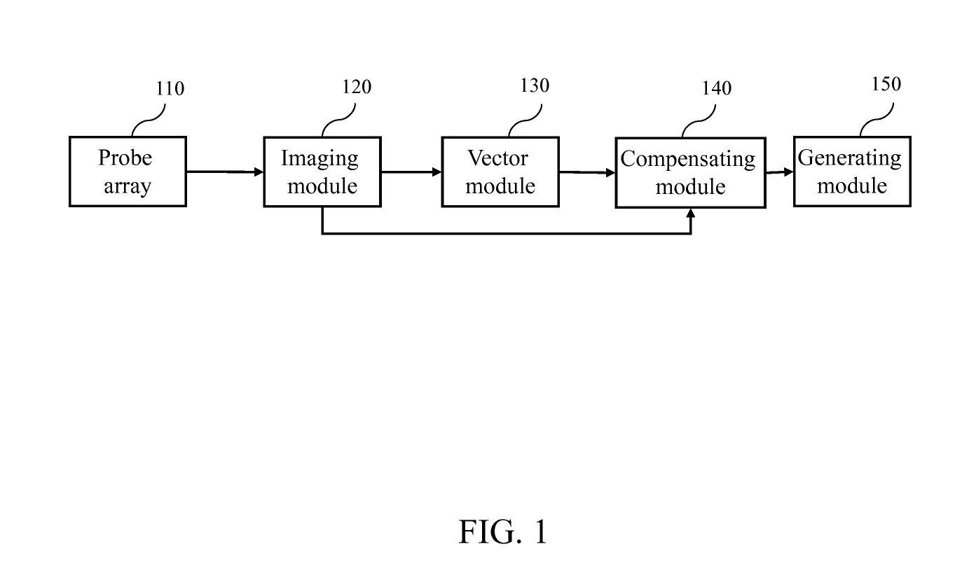

Please refer to FIG. 1, which is a system block diagram of the disclosed low complexity motion compensation beamforming system. The system includes: a probe array 110, an image forming module 120, a vector module 130, a compensating module 140, and a generating module 150. The probe array 110 has I probes. At the same time, J of the probes fire for beamforming. Here I and J are positive integers and J < I. The probe array 110 fires beamforming by synthetic apertures. That is, each time only some of the probes are used to fire for beamforming to form a LRI. Suppose there are 128 probes, and each time two of the probes fire beamforming. Then I=128 and J=2. Each of the probes has a channel buffer to store the amplitudes of reflected signals. Since aperture synthesis belongs the prior art, it is not further described herein.

The image forming module 120 continuously uses J probes of the probe array to fire for beamforming. The beamforming range of each firing is an ROI. The different ROI's are used in sequence to generate first to K-th LRI's, where K is a positive integer. In practice, the LRI's are generated from the amplitudes of reflected signals stored in channel buffers. Therefore, these LRI's can be considered as the amplitudes of the reflected signals. Besides, the ROI has beam defined in the beginning and is not repeated here.

The vector module 130 sequentially defines the overlapped region of each two adjacent ROI's as an overlapping ROI. The central image beam of the overlapping ROI is used to generate an image beam vector. In practice, the image beam vector in a previously generated overlapping ROI is used as a backward beam vector. The image beam vector in a subsequently generated overlapping ROI is used as a forward beam vector. That is, in a same overlapping ROI, there are the backward beam vector generated from the i-th firing and the forward beam vector generated from the (i-1)-th firing. It should be emphasized that the generation of the image beam vector using the central image beam of the overlapping ROI can be done simply using a single image beam or using a plurality of image beams. If only a single image beam is used, then the method can only calculate the axial displacement (i.e., one-dimensional). If multiple image beams are used, then displacements in the axial and lateral directions (i.e., two-dimensional) can be calculated.

The compensating module 140 uses cross-correlation to analyze the LRI's corresponding to the image beam vectors. The analysis result is used to compute an offset to compensate the second to the K-th LRI's and to produce first to (K−1)-th low resolution compensating images. In practice, the correlation analysis finds the point with the largest correlation between two LRI's and computes the axial offset and even the lateral offset. Therefore, the compensating module 140 can use the computed offsets to compensate the LRI's and to generate low resolution compensating images.

The generating module 150 combines the first LRI and the first to the (K−1)-th low resolution compensating images (which are still LRI's in essence, but compensated) generated in sequence by the compensating module 114 to generate an HRI. Since the technique of synthesizing multiple LRI's into an HRI belongs the prior art, it is not further described herein.

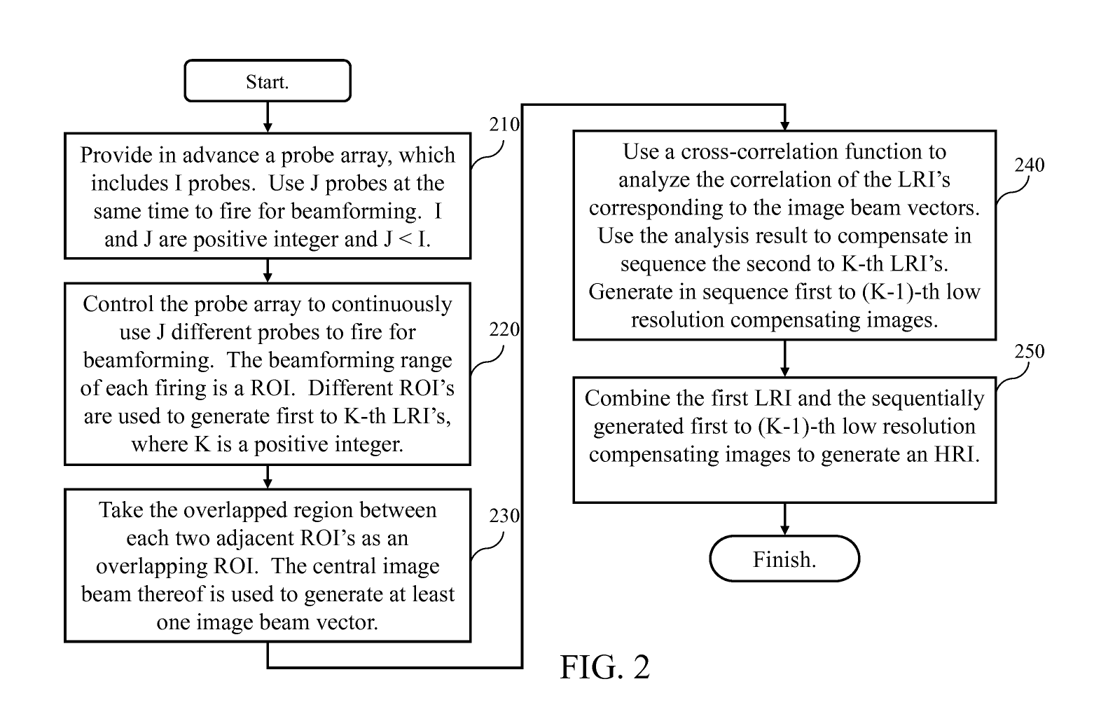

Please refer to FIG. 2, which is a flowchart of the disclosed low complexity motion compensation beamforming method. The method includes the following steps. In step 210, a probe array 110 is provided in advance. The probe array 110 includes I probes. J of the probes are used at the same time to fire for beamforming. Here I and J are positive integers, and J < I. In step 220, the probe array 110 continuously uses different J probes to fire for beamforming. The beamforming range of each firing is an ROI. Different ROI's are used in sequence to generate first to K-th LRI's, where K is a positive integer. In step 230, the overlapped region between two adjacent ROI's is taken as an overlapping ROI. The central images of the overlapping ROI's are used to generate image beam vectors. In step 240, a cross-correlation function is used to analyze the LRI's corresponding to the image beam vectors. The analysis result is then used to compute an offset for compensating in sequence the second to the K-th LRI's and generating in sequence first to (K−1)-th low resolution compensating images. In step 250, the first LRI and the sequentially generated first to (K−1)-th low resolution compensating images are combined to generate a HRI. Through the above-mentioned steps, the probe array is utilized to fire for beamforming via synthetic aperture. The beamforming range of each firing is the ROI. The overlapped region of each adjacent ROI's is defined as the overlapping ROI. The central image thereof is used to generate an image beam vector for the subsequent cross-correlation analysis on the LRI's. The analysis result is used to compute the offset for compensating the LRI's to generate the HRI.

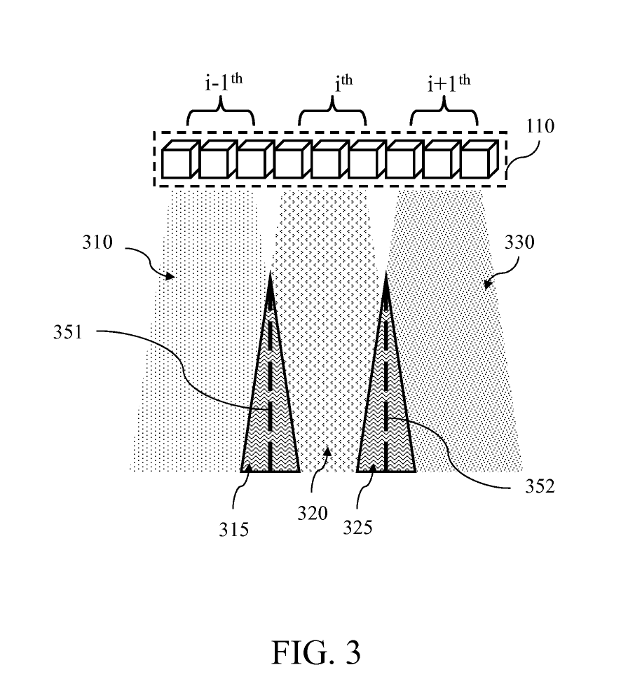

Please refer to FIGS. 3 to 5 for an embodiment of the invention. FIG. 3 is a schematic view of the disclosed probe array firing beamforming. As mentioned before, the synthetic aperture each time only uses part of the probe array to fire. The beamforming range of each firing is the ROI 310, 320, 330 shown in FIG. 3. The overlapped region between each adjacent two firings (e.g., (i−1)-th and i-th, i-th and (i+1)-th) is the overlapping ROI 315, 325. The central image beam (indicated by thick dashed line) of each of the overlapping ROI's 315, 325 is the image beam vector 351, 352. In particular, the image beam vector 351 is the backward beam vector of the i-th firing. The image beam vector 352 is the forward beam vector of the i-th firing. Likewise, the image beam vector 351 is also the forward beam vector of the (i−1)-th firing. The image beam vector 352 is also the backward beam vector of the (i+1)-th firing. It is seen in FIG. 3 that the backward beam vector of the i-th firing and the forward beam vector of the (i−1)-th firing completely overlap in the image. Therefore, using these two vectors to do cross-correlation analysis can find the points with the largest correlation in the corresponding to LRI's. They are used to compute the offset, with which the compensating module 140 compensates in sequence the LRI's. The generating module 150 then combines the first LRI and all the low resolution compensating images to generate an HRI.

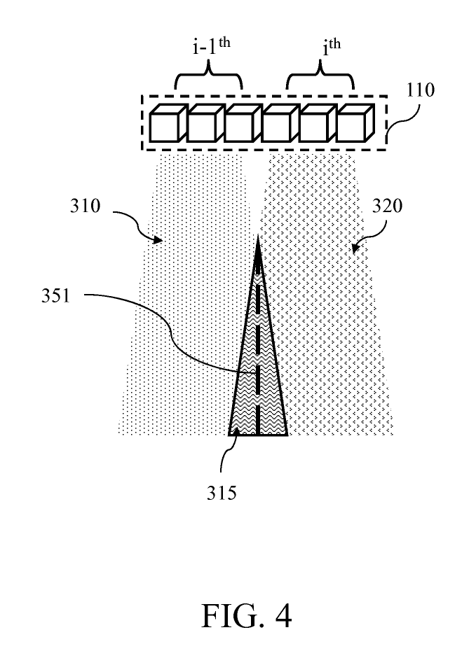

FIG. 4 is a schematic view of the forward beam vectors and backward beam vectors. For the convenience of explanation, the following description concentrates on the (i−1)-th and the i-th firings. As mentioned before, the image beam vector 351 is both the backward beam vector of the i-th firing and the forward beam vector of the (i−1)-th firing. Therefore, the positions of the LRI's completely overlap. When there is a motion, the LRI generated by the (i−1)-th firing and the LRI generated by the i-th firing are different. Take the 2-dimensional (2D) compensation as an example. The vector module 130 establishes several forward beam vectors in the overlapping ROI 315. In addition to using the backward beam vector and the forward beam vector at the center of the overlapping ROI 315 to compute cross-correlation for finding the axial displacement, the invention also uses the backward beam vector and different forward beam vectors in the overlapping ROI 315 to compute the lateral displacement. When there is a point with the largest correlation in the axial direction, the displacement is taken as the axial image offset. When there is a point with the largest correlation in the lateral direction, the displacement is taken as the lateral image offset. As a result, the axial image offset and the lateral image offset are used to compensate the LRI's, thereby generating low resolution compensating images.

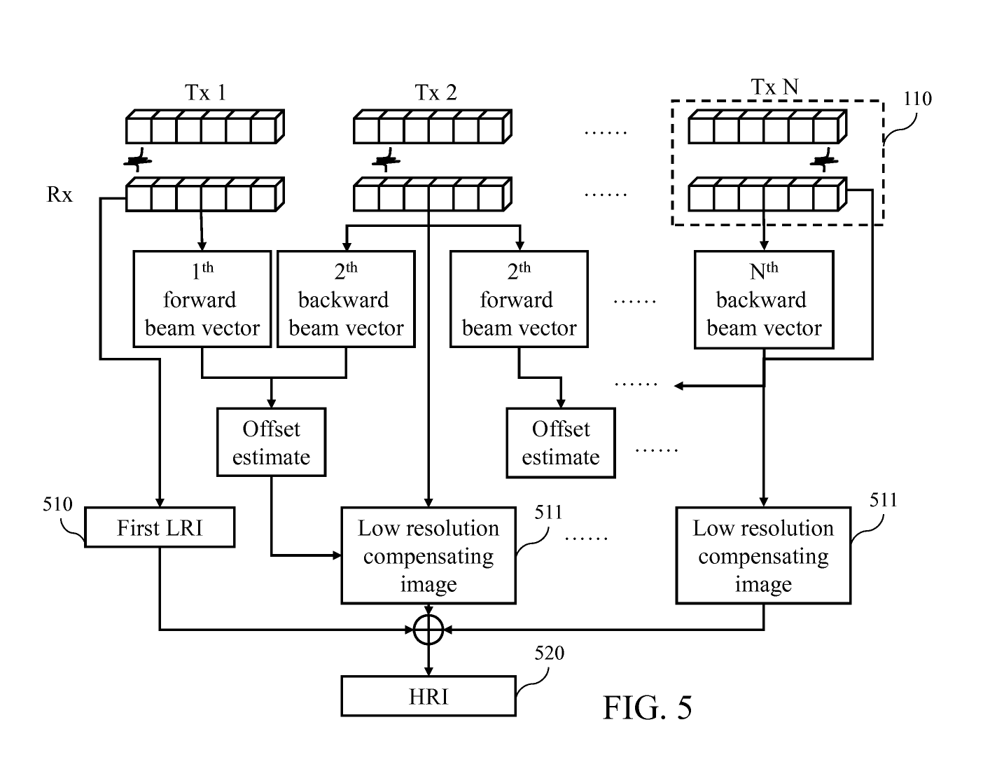

FIG. 5 is a schematic view of using the invention to generate an HRI. The probe array 110 can be viewed as transmission Tx and reception Rx. When the LRI's are formed in time, the image beam vectors are also formed for estimating the offset. After the first firing beamforming, the first LRI 510 is directly formed. After the second firing beamforming, the vector module 130 uses the overlapping ROI 315 to generate the image beam vector 351. The compensating module 140 uses the cross-correlation function to do the correlation analysis. The analysis result is used to compute the offset, thereby generating the first low resolution compensating image 511. This process continues until the (K−1)-th low resolution compensating image 511 is generated. That is, each firing is compared with the image beam vector of the previous firing to estimate the offset. The corresponding LRI is then compensated to generate the low resolution compensating image 511. After all the firings, the first LRI 510 and all the low resolution compensating images 511 (i.e., the compensated LRI's) are combined to generate the HRI 520 for output.

In summary, the invention differs from the prior art in that the invention uses the probe array to fire for beamforming via the synthetic aperture. The beamforming range of each firing is taken as the ROI. The overlapped region between each two adjacent ROI's is defined as the overlapping ROI. The central image beam of each of the overlapping ROI's is used to generate the image beam vector in order for the cross-correlation analysis of the corresponding LRI. The analysis result is used to compute the offset for compensating the images to produce the HRI. This technique can solve problems existing in the prior art. Moreover, the invention achieves the goal of improving ultrasonic imaging quality and frame fresh rate.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A low complexity motion compensating beamforming system, comprising:
a probe array, which includes I probes and J of the probes to fire for beamforming at the same time, where I and J are positive integers and J<I;
an imaging forming module, which controls the probe array to continuously use J different probes in the probe array to fire for beamforming, the beamforming range of each firing is taken as a region of interest (ROI), and the different ROI's are used to generate in sequence first to K-th low resolution images (LRI's), where K is a positive integer;
a vector module, which takes in sequence the overlapped region of each two adjacent ROI's as an overlapping ROI, and uses the central image beam of the overlapping ROI to generate at least one image beam vector;
a compensating module, which uses a cross-correlation function to analyze the correlation between the LRI's corresponding to the image beam vectors, and uses the analysis result to compensate in sequence the second to K-th LRI's and to generate in sequence first to (K−1)-th low resolution compensating images; and
a generating module, which combines the first LRI and the sequentially generated first to (K−1)-th low resolution compensating images to generate a high resolution image (HRI).

2. The low complexity motion compensating beamforming system of claim 1, wherein each of the image beam vectors is a backward beam vector of the previously generated overlapping ROI and a forward beam vector of the subsequently generated overlapping ROI, and the backward beam vector and the forward beam vector in the same overlapping ROI completely overlap in the position of the corresponding LRI.

3. The low complexity motion compensating beamforming system of claim 2, wherein the cross-correlation analysis uses the backward beam vector and the forward beam vector of the same overlapping ROI to find a point with the largest correlation, thereby computing an offset.

4. The low complexity motion compensating beamforming system of claim 2, wherein the central image beam of each of the overlapping ROI's sample at least one image beam to form the image beam vector, and sampling a single image beam is used for one-dimensional (1D) compensation and sampling multiple image beams is used for two-dimensional (2D) compensation.

5. The low complexity motion compensating beamforming system of claim 4, wherein the 1D compensation uses a single image beam to compute the offset in the axial direction, and the 2D compensation uses multiple image beams to compute the offsets in the axial and lateral directions.

6. A low complexity motion compensating beamforming method, comprising the steps of:
providing in advance a probe array, wherein the probe array includes I probes and J of the probes are used at the same time to fire for beamforming, where I and J are positive integers and J<I;
controlling the probe array to continuously use J different probes in the probe array to fire for beamforming, the beamforming range of each firing being an ROI, and generating in sequence first to K-th LRI's according to the different ROI's, where K is a positive integer;
taking the overlapped region of each two adjacent ROI's as an overlapping ROI, and using the central image beam of the overlapping ROI to generate at least one image beam vector;
using a cross-correlation function to analyze the correlation in the LRI's corresponding to the image beam vectors, and using the analysis result to compute an offset for compensating in sequence the second to K-th LRI's and generating in sequence first to (K−1)-th low resolution compensating images; and
combining the first LRI and the sequentially generated first to (K−1)-th low resolution compensating images to generate an HRI.

7. The low complexity motion compensating beamforming method of claim 6, wherein each of the image beam vectors is a backward beam vector of the previously generated overlapping ROI and a forward beam vector of the subsequently generated overlapping ROI, and the backward beam vector and the forward beam vector in the same overlapping ROI completely overlap in the position of the corresponding LRI.

8. The low complexity motion compensating beamforming method of claim 7, wherein the cross-correlation analysis uses the backward beam vector and the forward beam vector of the same overlapping ROI to find a point with the largest correlation, thereby computing an offset.

9. The low complexity motion compensating beamforming method of claim 7, wherein the central image beam of each of the overlapping ROI's sample at least one image beam to form the image beam vector, and sampling a single image beam is used for 1D compensation and sampling multiple image beams is used for 2D compensation.

10. The low complexity motion compensating beamforming method of claim 9, wherein the 1D compensation uses a single image beam to compute the offset in the axial direction, and the 2D compensation uses multiple image beams to compute the offsets in the axial and lateral directions.
